(19) United States
(12) Patent Application Publication
(10) Pub. No.: US 2008/0164432 A1
(43) Pub. Date: Jul. 10, 2008

(54) Floating Lifter Pressure Relief Valve

(75) Inventor: Gary Matsch, Phoenix, AZ (US)

Correspondence Address: GOODRICH CORPORATION;C/O THE CAVANAGH LAW FIRM, 1850 NORTH CENTRAL AVENUE, SUITE 2400, PHOENIX, AZ, 85004, US

(73) Assignee: GOODRICH CORPORATION, Charlotte, NC (US)

(21) Appl. No.: 11/857,829

(22) Filed: Sep. 19, 2007

Related U.S. Application Data
(60) Provisional application No. 60/878,802, filed on Jan. 5, 2007.

(51) Int. Cl. F16K 1/30; F16K 31/20; F16K 15/20

(52) U.S. Cl. 251/85; 244/137.2

(57) ABSTRACT

An inflatable evacuation slide has a pressure relief valve in at least one of the inflatable support tubes. The pressure relief valve has a “floating” lifter that slidingly engages the valve stem of the poppet valve portion of the pressure relief valve. Because the lifter floats on the valve stem, the lifter cannot load the poppet valve in compression. When the poppet valve opens, however, air pressure acting on the lifter causes the lifter to engage a stop at the end of the valve stem, which enables the lifter to fully open the poppet.

### CROSS-REFERENCE TO RELATED APPLICATION

The application claims priority of provisional application No. 60/878,802 filed Jan. 5, 2007.

### BACKGROUND OF THE INVENTION

This invention relates to emergency evacuation equipment for aircraft, in particular to inflatable emergency evacuation slides.

Current state of the art emergency evacuation slide systems comprise an inflatable evacuation slide that is stored in a folded, uninflated state together with a source of inflation gas inside a compartment often referred to as a packboard. The source of inflation gas typically comprises a hybrid inflator, which utilizes a compressed gas stored in a pressure vessel together with a pyrotechnic gas generator. The pyrotechnic gas generator augments the stored compressed gas by providing additional gas as well as heat to counteract effects of expansion-induced cooling of the compressed gas as it expands out of the pressure vessel and into the inflatable emergency evacuation slide.

Inflatable emergency evacuation slides must operate reliably over a wide ambient temperature range, typically from −65° F. to +160° F. The amount of gas available must be enough to pressurize the evacuation slide at the coldest temperature. Because of the relationship between pressure and temperature within a fixed volume, however, as the ambient temperature rises above the minimum, the pressure of the stored inflation gas rises proportionately. Accordingly, at higher temperatures, the inflation system produces substantially more gas than is necessary to inflate the evacuation slide. To prevent over pressurization and possible rupturing of the inflatable evacuation slide, provisions must be made to vent the excess inflation gas.

A conventional method of venting the excess inflation gas is to provide several pressure relief valves in the inflatable slide itself. These pressure relief valves must open at a precise pressure to ensure that the inflatable evacuation slide is neither underinflated nor overinflated. The pressure relief valve itself must be as lightweight as possible and occupy a minimum amount of volume within the packboard. It also must withstand the substantial packing loads exerted on it as a result of the evacuation slide being stored within the tight confines of the packboard.

Conventional fixed-lifter pressure relief valves have a drawback in that packing loads exerted on the lifter can cause deformation of the valve poppet seal. This deformation can lead to leakage of the valve and premature opening of the pressure valve during inflation of the slide. Accordingly, what is needed is a simple and reliable pressure relief valve that maintains its integrity and operating pressure in spite of the severe packing loads exerted on the pressure relief valve body.

### SUMMARY OF THE INVENTION

The present invention comprises an inflatable evacuation slide having a pressure relief valve in at least one of the inflatable support tubes that support the inflatable evacuation slide. According to an illustrative embodiment, the pressure relief valve has a “floating” lifter that slidingly engages the valve stem of the poppet valve portion of the pressure relief valve. Because the lifter floats on the valve stem, the lifter cannot load the poppet valve in compression. When the poppet valve opens, however, air pressure acting on the lifter causes the lifter to engage a stop at the end of the valve stem. This enables the lifter to fully open the poppet to prevent it from chattering. In the illustrative embodiment, the lifter includes a recess that is deeper than the height of the stop at the end of the valve stem. The recess protects the valve stem from any direct compressive loads on the end of the valve stem.

### BRIEF DESCRIPTION OF THE DRAWING

The present invention will be better understood from a reading of the following detailed description taken in conjunction with the accompanying drawing figures in which like references designate like elements and, in which:

FIG. 1 is a side view of an inflatable evacuation slide incorporating features of the present invention;

FIG. 2 is a cross-sectional view of a prior art pressure relief valve;

FIG. 3 is a cross-sectional view of a pressure relief valve incorporating features of the present invention with the lifter portion seated against the valve body;

FIG. 4 is a cross-sectional view of the pressure relief valve of FIG. 3 with the lifter engaging the stop at the end of the valve stem; and

FIG. 5 is an exploded perspective view of the pressure relief valve of FIGS. 3 and 4.

### DETAILED DESCRIPTION

The drawing figures are intended to illustrate the general manner of construction and are not necessarily to scale. In the detailed description and the drawing figures, specific illustrative examples are shown and herein described in detail. It should be understood, however, that the drawing figures and detailed description are not intended to limit the invention to the particular form disclosed, but are merely illustrative and intended to teach one of ordinary skill how to make and/or use the invention claimed herein and for setting forth the best mode for carrying out the invention.

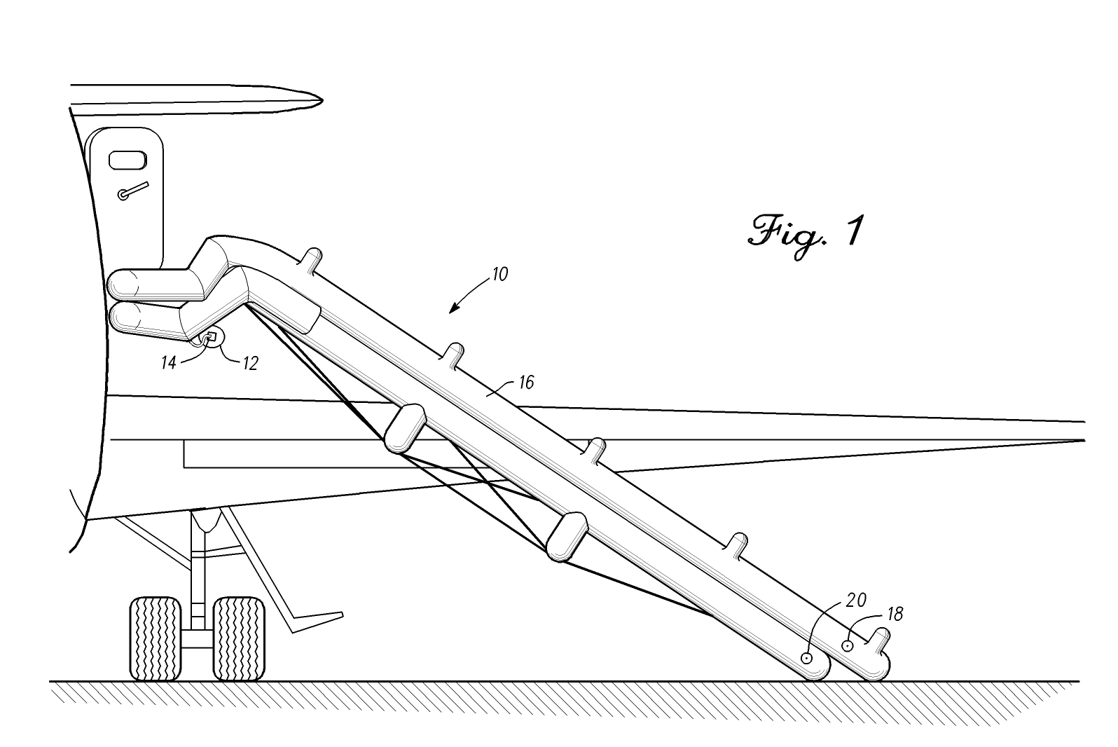

With reference to FIG. 1, an inflatable evacuation slide system 10 incorporating features of the present invention comprises a pressure vessel 12 containing a pressurized inflation gas, a control valve 14 and an inflatable evacuation slide 16. Evacuation slide system 10 is stored in an uninflated condition within a compartment known as a packboard, which is secured within a recess in the aircraft fuselage, attached to the inside surface of an exit door or otherwise secured within the confines of the aircraft. In normal operation, the opening the aircraft emergency evacuation exit in the armed condition causes a signal to be sent to the control valve 14 causing control valve 14 to open allowing inflation gas to flow from pressure vessel 12 into inflatable evacuation slide 16. Simultaneously the gas generator within the pressure vessel (not shown) is initiated to augment and heat the stored inflation gas flowing out of pressure vessel 12. As noted hereinbefore, when evacuation slide system 10 is initiated at an elevated temperature, substantial excess inflation gas is produced due to the combined thermal effects of the ambient temperature and the pyrotechnic gas generator. Accordingly, to vent the excess inflation gas, inflatable evacuation slide 16 is provided with one or more pressure relief valves 18 and 20, which open at a predetermined pressure range typically about 2.5 to 3.0 psig.

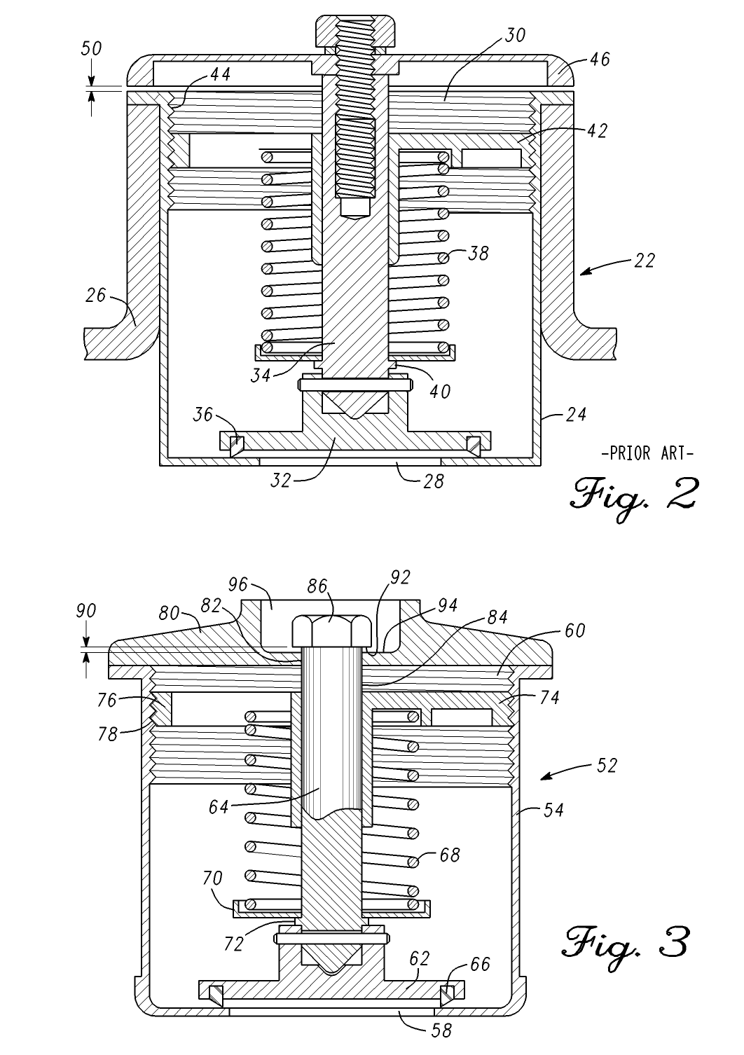

As shown in FIG. 2, a prior art pressure relief valve 22 comprises a valve body 24 that is sealed to a flange 26 formed in the inflatable evacuation slide so that the inlet aperture 28 is in fluid communication with the interior volume of the inflatable evacuation slide while the exhaust aperture 30 is open to the atmosphere. A poppet valve consisting of a valve member 32, valve stem 34 and elastomeric seal 36 seals inlet aperture 28 against the internal pressure within the interior volume of the evacuation slide. Sealing pressure is provided by a valve spring 38 which is captive between a boss 40 formed on valve stem 34 and spring seat 42. The relief pressure is adjusted by means of a threaded engagement 44 between spring seat 42 and valve body 24 which is employed to adjust the length and therefore the compression of valve spring 38 by moving spring seat toward and away from valve member 32.

In order to prevent chattering of the poppet valve during operation, prior art pressure relief valve 22 includes a lifter 46, which is rigidly attached to valve stem 34. Because the area of lifter 46 is greater than the area of valve member 34, once valve member 32 opens, air rushing past valve member 32 causes lifter 46 to fully unseat valve member 32 until the pressure acting on valve member 32 drops below the threshold. This built-in hysteresis reduces chattering of the valve member 32 during operation.

Lifter 46 of prior art valve 22 is spaced apart from valve body 24 by a precisely controlled gap 50 of approximately 0.005 inches. This gap is necessary to ensure that thermal expansion of valve body 24 or settling of the elastomeric seal 36 will not cause lifter 46 to open valve member 32 prematurely. Unfortunately, however, packing loads caused by the inflatable evacuation slide system being forced into a packboard compartment causes lifter 46 to be pressed against valve body 24 until gap 50 is closed entirely. Further deformation of lifter 46 places excessive compressive loads on elastomeric seal 36. This causes elastomeric seal 36 to take a permanent compression set, leading to unreliable operation.

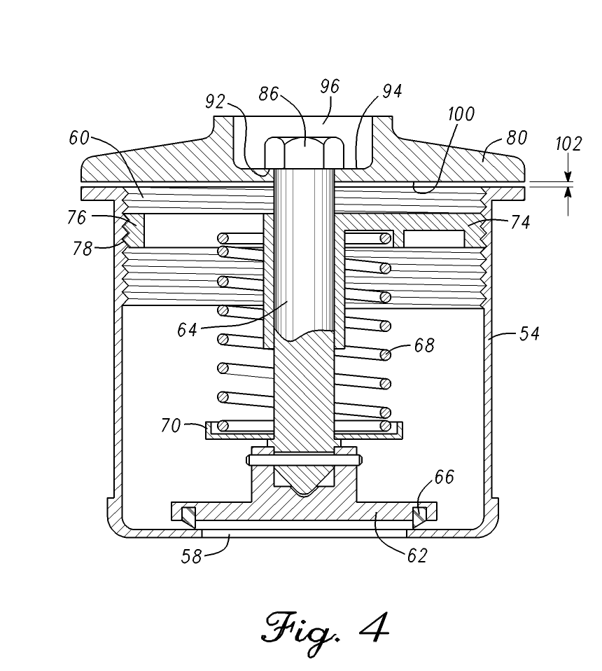

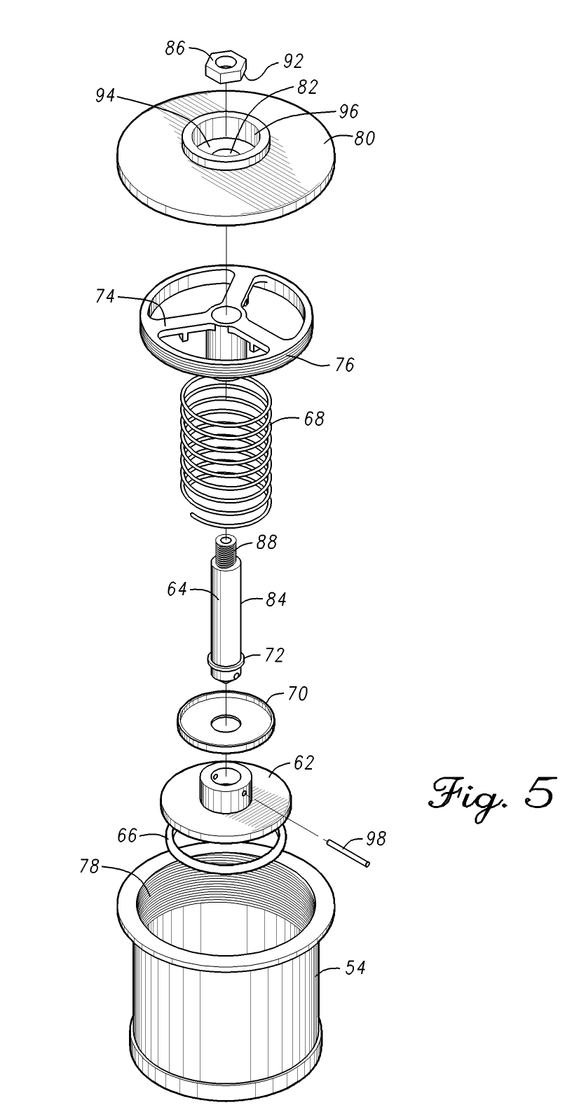

With reference to FIGS. 3-5, a “floating lifter” pressure relief valve 52 incorporating features of the present invention comprises a valve body 54 which is secured to a flange (not shown) so that the inlet aperture 58 is in fluid communication with the interior volume of the inflatable evacuation slide and the exhaust aperture 60 vents to the atmosphere. As with the prior art pressure relief valve, inlet aperture 58 is sealed by means of a poppet valve assembly consisting of a valve member 62, which is rigidly attached to a valve stem 64, for example by a roll pin 98. The poppet valve assembly further includes an elastomeric seal 66 mounted in valve member 62 and pressed against inlet aperture 58 by means of a valve spring 68. Valve spring 68 is captive between a spring cup 70 which rides on a boss 72 formed on a valve stem 64 and a spring seat 74. Male threads 76 formed on spring seat 74 engaged female threads 78 formed in valve body 54 to enable the compression of valve spring 68 to be adjusted.

Pressure relief valve 52 further includes a lifter member 80 which comprises a disk-shaped body having a central aperture 82 that slidingly engages the outer diameter 84 of valve stem 64. Because lifter member 80 slidingly engages valve stem 64, it is incapable of exerting a compressive force on elastomeric seal 66 no matter how much it deforms under packing loads. Lifter member 80 performs its lifting function, however, by engaging a stop member 86 such as a stop nut threaded onto the end 88 of valve stem 64.

In order to prevent thermal expansion of valve body 54 or settling of the elastomeric seal 66 from causing premature opening of valve member 62, a precise gap 90 of 0.020 to 0.035 inch is maintained between the lower surface 92 of stop member 86 and the upper surface 94 of the recess 96 formed in lifter member 80. As can be determined from FIG. 3, recess 96 is deeper than the combination of gap 90 and the height of stop member 86. This ensures that packing loads cannot act directly on stop member 86 to compress elastomeric seal 66.

In operation, as valve member 62 begins to open, air pressure flowing through inlet aperture 58 into the interior of valve body 54 acts on the lower surface 100 of lifter member 80. This air pressure causes lifter member 80 to move axially outward until it engages the lower surface 92 of stop member 86. In doing so, gap 90 is reduced to zero and a new gap 102 forms between lifter member 80 and valve body 54. Additional air flowing into inlet aperture 58 causes lifter member 80 to press against stop member 86, which in turn causes it to displace valve stem 64 and with it valve member 62 axially away from inlet aperture 58. As can be determined from the foregoing, by providing a sliding engagement between lifter member 80 and valve stem 64, lifter member 80 floats on valve stem 64 and thus is incapable of compressively elastomeric seal 66. At the same time, providing a stop member that engages lifter member 80 as it moves away from inlet aperture 58 enables lifter member 80 to perform its function of opening valve member 62 when the pressure within the inflatable evacuation slide exceeds the predetermined threshold.

Although certain illustrative embodiments and methods have been disclosed herein, it will be apparent from the foregoing disclosure to those skilled in the art that variations and modifications of such embodiments and methods may be made without departing from the spirit and scope of the invention. Accordingly, it is intended that the invention shall be limited only to the extent required by the appended claims and the rules and principles of applicable law.

What is claimed is:

1. In combination with an inflatable evacuation slide comprising a plurality of inflatable support tubes adapted to be deployed from an elevated supporting surface to a lower supporting surface, a pressure relief valve attached to an opening in at least one of said plurality of inflatable support tubes, said pressure relief valve comprising:
a valve body having a inlet aperture opening into said one of said plurality of inflatable support tubes and a exhaust aperture for venting outside said valve body, the inlet aperture including a valve seat;
a poppet comprising a valve stem having a first end and a second end having a first valve member attached thereto, said first valve member having a front face for sealingly engaging said valve seat, said poppet being moveable axially along an axis of said valve stem from a closed position in which said first valve member sealing engages said valve seat to an open position in which said first valve member is displaced axially away from said valve seat;
a valve spring urging said poppet into said closed position;
a lifter member slidingly engaging said first end of said valve stem, said lifter member having a front face and being movable from a first position in which said front face contacts said exhaust aperture, to a second position in which said lifter member is spaced apart from said exhaust aperture and engages a stop member on the first end of the valve stem, said lifter member further moveable to a third position in which said lifter member presses against the stop member and displaces said valve stem axially away from said valve seat.

2. The pressure relief valve of claim 1, wherein:
said inlet aperture is smaller in area than said exhaust aperture

3. The pressure relief valve of claim 1, wherein:
said lifter member is spaced apart from said aperture a distance of 0.020 to 0.035 inches in said second position.

4. The pressure relief valve of claim 1, wherein:
said stop member comprises a threaded fastener moveable along said valve stem, whereby said lifter member is spaced apart from said exhaust aperture in said second position by a variable distance.

5. The pressure relief valve of claim 1, wherein,
said first valve member has a resilient face

6. The pressure relief valve of claim 1, wherein:
said inflatable evacuation slide is packed into a compartment prior to deployment whereby said valve is subjected to external compression loads.

7. The pressure relief valve of claim 1, wherein:
said lifter member has a recess formed in the upper surface thereof.

8. In combination with an inflatable evacuation slide comprising a plurality of inflatable support tubes adapted to be deployed from an elevated storage compartment, a pressure relief valve attached to an opening in at least one of said plurality of inflatable support tubes, said pressure relief valve comprising:
a valve body having a inlet aperture opening into said one of said plurality of inflatable support tubes and a exhaust aperture for venting outside said valve body, the inlet aperture including a valve seat;
a poppet comprising a valve stem having a first end and a second end having a valve member attached thereto, said valve member having a front face for sealingly engaging said valve seat, said poppet being moveable axially along an axis of said valve stem from a closed position in which said valve member sealing engages said valve seat to an open position in which said valve seat is displaced axially away from said valve seat;
a valve spring urging said poppet into said closed position;
a lifter member comprising a disk shaped member having a central aperture and an upper surface, said valve stem passing through said central aperture and terminating in a stop member, said stop member having a lower surface, the lower surface of said stop member and the upper surface of said lifter member defining a predetermined gap.

9. The pressure relief valve of claim 8, wherein:
said stop member has a thickness dimension and lifter member has a recess formed in the upper surface thereof, said recess having a depth at least equal to the thickness dimension of said stop member plus said predetermined gap, whereby said stop member is at all times fully contained within said recess.

10. The pressure relief valve of claim 9, wherein:
said inflatable evacuation slide is packed into a compartment prior to deployment, said evacuation slide applying compressive load to said valve.
